(19) United States
(12) Patent Application Publication
(10) Pub. No.: US 2009/0249347 A1
(43) Pub. Date: Oct. 1, 2009

(54) VIRTUAL MULTIPROCESSOR, SYSTEM LSI, MOBILE PHONE, AND CONTROL METHOD FOR VIRTUAL MULTIPROCESSOR

(75) Inventor: Masanori HENMI, Kyoto (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/411,563

(22) Filed: Mar. 26, 2009

(30) Foreign Application Priority Data
Mar. 27, 2008 (JP) 2008-084819

(51) Int. Cl. G06F 15/76; G06F 9/06; G06F 1/04; G06F 9/46

(52) U.S. Cl. 718/102; 712/30; 713/600; 712/E09.003

(57) ABSTRACT

A virtual multiprocessor according to the present invention includes: one or more processors that execute programs while switching between the programs at each of assigned times; a scheduling unit that performs scheduling that determines execution sequence of the programs and the one or more processors that are to execute one or more of the programs, wherein the scheduling unit performs the scheduling at a timing dependent on an assigned time associated with a corresponding one of the programs being executed by the one or more processors, in the case where a first mode is set, and performs the scheduling at a timing not dependent on the assigned time so that at least one of the one or more processors does not execute the programs, in the case where a second mode is set.

### BACKGROUND OF THE INVENTION

(1) Field of the Invention

The present invention relates to a virtual multiprocessor, a system LSI, a mobile phone, and a control method for the virtual multiprocessor, and in particular to a virtual multiprocessor that executes programs while switching between the programs.

(2) Description of the Related Art

In recent years, a demand for mobile communication apparatuses such as mobile phones has been growing rapidly. Accordingly, a demand for LSI for mobile communication apparatus has also been growing increasingly. As power is supplied from a battery to a mobile communication apparatus, reducing power consumption in the LSI for mobile communication apparatus is important.

On the other hand, a virtualization technology in particular has been recently attracting attention in the field of processor development. Many processor virtualization techniques have been developed. Among those, Intel Virtualization Technology, a function for supporting virtualization of CPU developed by Intel Corporation, is well-known. Furthermore, a technique described in Japanese Unexamined Patent Application Publication No. 2007-504541 (Patent Reference 1) is known as a technique relevant to the present invention. Patent Reference 1 describes the technique for reducing overhead when creating or discarding threads.

However, there are following problems with the above conventional technique.

In the case where programs are executed in parallel on a virtual multiprocessor, a scheduler configured with hardware usually determines which physical processor among physical processors included in the virtual multiprocessor is caused to execute every program. In addition, from a viewpoint of improving program execution parallelism, it is not usually specified as to which physical processor executes a program.

In the case where, for instance, mobile phone application programs are executed on the virtual multiprocessor, the application programs are classified into host processing programs and media processing programs.

A host processing program is a program mainly for system control, and a media processing program is a program mainly for voice call processing and image processing.

In the case where a period of time in which media processing programs are paused occurs, the virtual multiprocessor continues to execute only host processing programs and performs control not to execute the media processing programs. Since the virtual multiprocessor has a small amount of processing in the period of time in which the media processing programs are paused, operations of some physical processors among physical processors are suspended. Specifically, supplying clocks to the physical processors of which operations are to be suspended is suspended. Accordingly, power consumption of LSI is reduced.

However, as the scheduler configured with the hardware determines physical processors which execute the host processing programs and the media processing programs, it is difficult to perform control to suspend the clock supply with low granularity. In addition, since the scheduler performs scheduling at every predetermined time, the scheduler cannot perform the scheduling at once when switching to a low power mode in which the operations of some physical processors are suspended. That is, with the conventional virtual multiprocessor, there is a problem that overhead is large when switching to the low power mode.

### SUMMARY OF THE INVENTION

It is an objective of the present invention to provide a virtual multiprocessor that can reduce the overhead when switching to the low power mode.

In order to achieve the above objective, a virtual multiprocessor according to the present invention includes: one or more processors that execute programs while switching between the programs at each of assigned times; a scheduling unit configured to determine execution sequence of the programs and the one or more processors that are to execute one or more of the programs; an assigned time register that holds the assigned times each of which is associated with a corresponding one of the programs; and a mode register in which one of a first mode and a second mode is set, wherein the scheduling unit is configured to determine the execution sequence of the programs and the one or more processors that are to execute the one or more of the programs, at a timing dependent on an assigned time associated with a corresponding one of the programs being executed by the one or more processors, in the case where the first mode is set in the mode register, and to determine the execution sequence of the programs and the one or more processors that are to execute the one or more of the programs so that at least one of the one or more processors does not execute the programs, at a timing not dependent on the assigned time, in the case where the second mode is set in the mode register.

With this configuration, the scheduling unit included in the virtual multiprocessor according to the present invention does not cause some of the processors to execute the programs in the second mode (low-power mode). Accordingly, suspending clock supply to the processors not executing the programs can reduce the power consumption. For example, in the case where mobile phone application programs are executed on the virtual multiprocessor according to the present invention, the scheduling unit causes processors to execute only host processing programs in the second mode, thereby suspending media processing.

Further, when switching to the second mode, the virtual multiprocessor according to the present invention performs scheduling at the timing not dependent on the assigned time associated with the corresponding one the programs. As this enables the virtual multiprocessor according to the present invention to perform the scheduling immediately at the time of switching to the second mode, overhead when switching to the second mode can be reduced.

Moreover, the virtual multiprocessor may further include a clock suspension unit configured to suspend clock supply to a processor that is not executing the programs, among the one or more processors, in the case where the second mode is set in the mode register.

With this configuration, the virtual multiprocessor according to the present invention can reduce power consumption by suspending the clock supply to a processor not in operation.

Furthermore, one or more processors may be a plurality of processors, and the scheduling unit may determine the execution sequence of the programs and the one or more processors that are to execute the one or more of the programs so that only some of the plurality of processors execute the programs, in the case where the second mode is set in the mode register.

In addition, the scheduling unit may detect a change in a setting of the mode register, and determine the execution sequence of the programs and the one or more processors that are to execute the one or more of the programs so that the at least one of the one or more processors does not execute the programs, at the timing not dependent on the assigned time, when the change from the first mode to the second mode is detected.

Moreover, the scheduling unit may temporarily suspend execution of some of the programs being executed by the plurality of processors, when the setting of the mode register is changed from the first mode to the second mode, and cause the plurality of processors to preferentially execute the programs whose execution has been temporarily suspended, after the setting of the mode register is changed from the second mode to the first mode.

With this configuration, in the case of switching to the first mode again after the first mode is switched to the second mode, the virtual multiprocessor according to the present invention can continue to execute the programs that were being executed in the previous first mode.

Furthermore, the programs may include one or more first programs and one or more second programs, and the scheduling unit may: determine the execution sequence of the programs and the one or more processors that are to execute the one or more of the programs so as to cause each of the one or more processors to execute one of the one or more first programs and the one or more second programs; in the case where the first mode is set in the mode register, cause some of the plurality of processors that are executing one of the one or more first programs to continue to execute the one of the one or more first programs; and cause some of the plurality of processors that are executing one of the one or more second programs to temporarily suspend execution of the one of the one or more second programs.

With this configuration, in the case where the second mode is set, the scheduling unit causes the processors to execute only a host processing program (first program), thereby suspending the execution of a media processing program (second program).

In addition, the setting of the mode register may be changed by the one of the one or more first programs executed by the plurality of processors, and the scheduling unit may cause a processor that is executing a third program to continue to execute the third program, among the plurality of processors, when the setting of the mode register is changed from the first mode to the second mode by the third program, and cause a processor that is executing programs other than the third program to temporarily suspend execution of the programs, among the plurality of processors, the one or more first programs including the third program.

With this configuration, the virtual multiprocessor according to the present invention can execute only the host processing program in the second mode.

Moreover, the virtual multiprocessor further may include a program setting register in which one of a first value and a second value is set to each of the first programs, wherein the scheduling unit may cause the only some of the plurality of processors to execute, among the first programs, first programs to which the first value is set in the program setting register, while switching between the first programs to which the first value is set.

With this configuration, the virtual multiprocessor according to the present invention can execute host processing programs in the second mode.

Furthermore, the virtual multiprocessor may further include: a program setting register in which one of a first value and a second value is set to each of the first programs; and a number-of-processors register in which the number of processors that execute the programs in the second mode, among the plurality of processors, is set, wherein the scheduling unit may cause a number of the plurality of processors equaling the number of processors set in the number-of-processors register to execute, among the first programs, first programs to which the first value is set in the program setting register, in the case where the second mode is set in the mode register.

With this configuration, the virtual multiprocessor according to the present invention can cause the processors to execute in parallel the host processing programs in the second mode.

In addition, the one or more processors may be one processor, and the scheduling unit may inhibit the one processor from executing the programs, in the case where the second mode is set in the mode register.

Moreover, a system LSI according to the present invention includes the virtual multiprocessor.

Furthermore, a mobile phone according to the present invention includes the system LSI.

In addition, a control method for use in a virtual multiprocessor that includes one or more processors that execute programs while switching between the programs at each of assigned times, a scheduling unit that determines execution sequence of the programs and the one or more processors that are to execute one or more of the programs, an assigned time register that holds the assigned times each of which is associated with a corresponding one of the programs, and a mode register in which one of a first mode and a second mode is set, the control method includes: determining, by the scheduling unit, the program sequence of the programs and the one or more processors that are to execute the one or more of the programs, at a timing dependent on an assigned time associated with a corresponding one of the programs being executed by the one or more processors, in the case where the first mode is set in the mode register; and determining, by the scheduling unit, the execution sequence of the programs and the one or more processors that are to execute the one or more of the programs so that at least one of the one or more processors does not execute the programs, at a timing not dependent on the assigned time, in the case where the second mode is set in the mode register.

It is to be noted that the present invention can be realized not only as the virtual multiprocessor but also as the control method for use in the virtual multiprocessor having, as steps, characteristic units included in the virtual multiprocessor and a program causing a computer to execute the characteristic steps. Needless to say, such program can be distributed via recording media such as CD-ROMs and transmission media such as the Internet.

As described above, the present invention can provide the virtual multiprocessor that can reduce the overhead when switching to the low power mode and the control method for use in the system LSI, the mobile phone, and the virtual multiprocessor.

### FURTHER INFORMATION ABOUT TECHNICAL BACKGROUND TO THIS APPLICATION

The disclosure of Japanese Patent Application No. 2008-084819 filed on Mar. 27, 2008 including specification, drawings and claims is incorporated herein by reference in its entirety.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a block diagram showing a configuration of a virtual multiprocessor according to Embodiment 1 of the present invention;

FIG. 2 is a diagram showing a configuration of a register for holding states of logic processors according to Embodiment 1 of the present invention;

FIG. 3 is a diagram showing a configuration of a quantum register according to Embodiment 1 of the present invention;

FIG. 4 is a diagram showing a configuration of a sleep mode register according to Embodiment 1 of the present invention;

FIG. 5 is a diagram showing the state transition of a logic processor according to Embodiment 1 of the present invention;

FIG. 6A is a diagram showing an example of logic processors assigned to physical processors in a normal mode according to Embodiment 1 of the present invention;

FIG. 6B is a diagram showing an example of states of logic processors in a normal mode according to Embodiment 1 of the present invention;

FIG. 7A is a diagram showing an example of logic processors assigned to physical processors in a sleep mode according to Embodiment 1 of the present invention;

FIG. 7B is a diagram showing an example of states of logic processors in a sleep mode according to Embodiment 1 of the present invention;

FIG. 8 is a flow chart showing an operation flow of a virtual multiprocessor according to Embodiment 1 of the present invention;

FIG. 9 is a diagram showing a configuration of an LP control register according to Embodiment 1 of the present invention;

FIG. 10 is a diagram showing a configuration of a PP control register according to Embodiment 1 of the present invention; and

FIG. 11 is a block diagram showing a configuration of a mobile phone according to Embodiment 2 of the present invention.

### DESCRIPTION OF THE PREFERRED EMBODIMENT

The following will describe in detail embodiments of a virtual multiprocessor according to the present invention with reference to the drawings.

### Embodiment 1

In a virtual multiprocessor according to Embodiment 1 of the present invention, a scheduler causes processors to execute host processing programs or media processing programs in a normal mode, and some processors to execute only the host processing programs in a low power mode.

Consequently, as the virtual multiprocessor according to Embodiment 1 of the present invention performs clock control with low granularity, overhead when switching to the low power mode can be reduced.

First, a configuration of the virtual multiprocessor according to Embodiment 1 of the present invention will be described.

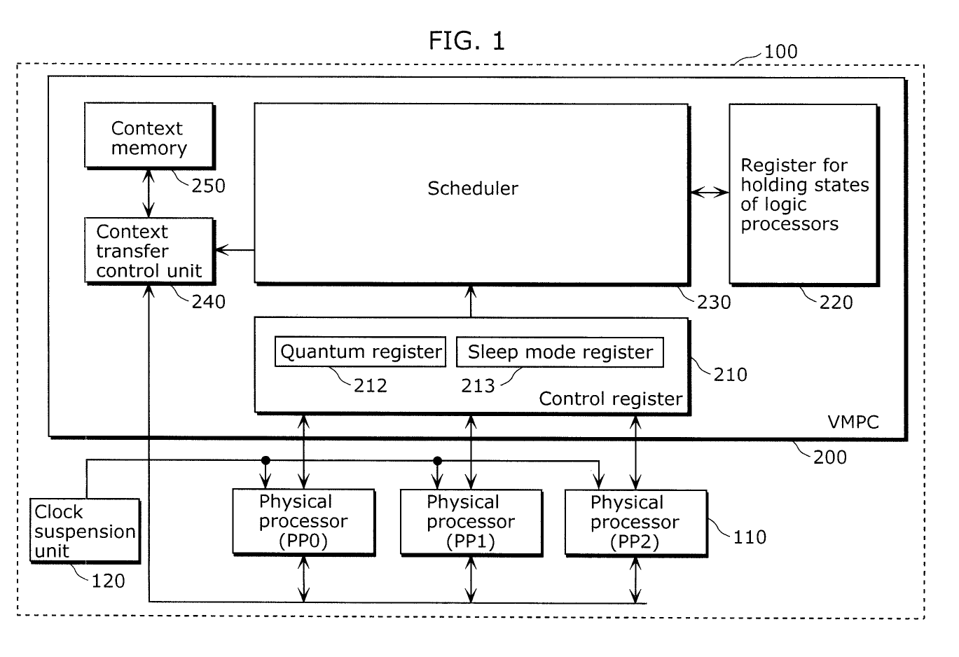

FIG. 1 is a block diagram showing the configuration of the virtual multiprocessor according to Embodiment 1 of the present invention.

A virtual multiprocessor 100 shown in FIG. 1 executes programs in parallel. The virtual multiprocessor 100 executes, for example, mobile phone application programs. In addition, the virtual multiprocessor 100 has a sleep mode, which is a low power mode in which power consumption is reduced, and a normal mode in which operations are performed at a normal level of power consumption.

The virtual multiprocessor 100 includes physical processors 110, a virtual multiprocessor controller (hereafter, VMPC) 200, a clock suspension unit 120.

The physical processors 110 (hereafter, also referred to as PP, and three PPs included in the virtual multiprocessor 100 are referred to as PP0 to PP2, respectively) execute programs in parallel. Furthermore, the physical processors 110 execute the programs while switching between the programs at regular time intervals.

As seen from each of the programs, it appears that respective programs are executed on a virtually independent processor. This virtual processor is a logic processor (hereafter, LP). A program is executed on an LP. When a program is executed on a PP, an LP corresponding to the program is assigned to the PP.

An LP has the following five operation states: a running state; a ready state; a waiting state; a suspended ready state; and a suspended waiting state.

The running state is a state in which a program is being executed on a PP. The ready state is a state in which a program can be executed but an LP is ready because no PP can execute the program. The waiting state is a state in which some external events (completion of DMA transfer or the like) are waited for. The suspended ready state is a state in which program execution is temporarily suspended due to an external event. The suspended waiting state is a state in which program execution is temporarily suspended due to an external event and some external events are waited for.

The VMPC 200 controls program execution performed by the physical processors 110. The VMPC 200 includes a control register 210, a register for holding states of logic processors 220, a scheduler 230, a context transfer control unit 240, and a context memory 250.

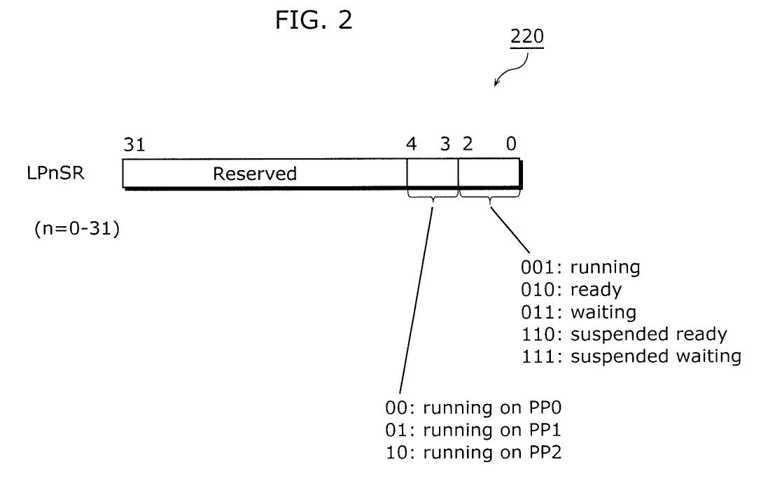

The register for holding states of logic processors 220 is a register for managing states of LPs. FIG. 2 is a diagram showing a configuration of the register for holding states of logic processors 220.

The register for holding states of logic processors 220 includes 32 registers (a register LP0SR, a register LP1SR, . . . , and a register LP31SR). Each of registers LPnSR (where n=0 to 31 or n is an ID of an LP) holds information specifying a PP to which an LP is assigned and an operation state of the LP.

The zeroth to second bits of the LPnSR register indicate an operation state of an LP. The third and fourth bits of the LPnSR register indicate which PP a corresponding LP is assigned to. Furthermore, a priority is managed with an ID of an LP. For example, the priority is higher with a smaller ID of an LP, and a priority of an LP corresponding to an executed program is set the lowest.

The register for holding states of logic processors 220 is updated by the scheduler 230.

The control register 210 is a register for controlling the scheduler 230. The control register 210 includes a quantum register 212 and a sleep mode register 213.

The quantum register 212 includes 32 registers LPnQTMR (where n=0 to 31).

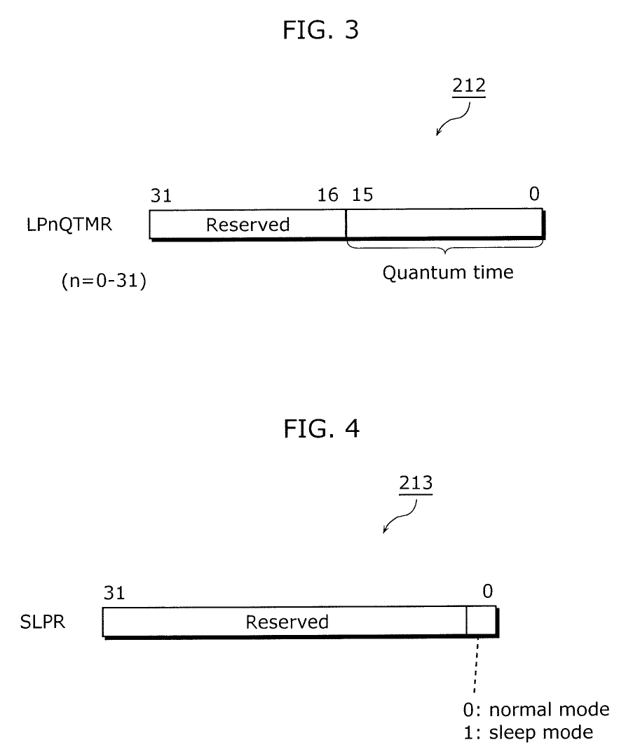

FIG. 3 is a diagram showing a configuration of the quantum register 212. Each of the registers LPnQTMR holds a quantum time of a corresponding LP. The quantum time is a unique time that a user has given to each of programs, and is a time at which each of programs corresponding to a corresponding one of LPs is executed on a PP. To put it differently, the quantum time is a time at which an LP is assigned to a PP. In addition, the quantum time held by the quantum register 212 is set by the program executed on the PP.

When an execution time of a program corresponding to an LP becomes equal to a quantum time corresponding to the LP, the scheduler 230 assigns another LP scheduled in advance to a PP so as to switch between the program executed and a program to be executed on the PP. Specifically, the scheduler 230 counts the execution time of the program, and switches between LPs when a count value becomes equal to a quantum time.

The sleep mode register 213 is a register in which either a sleep mode or a normal mode is set. The sleep mode register 213 is updated by a program executed on a PP. In other words, the sleep mode register 213 is a register in which the program executed on the PP requests a switch from the normal mode to the sleep mode.

FIG. 4 is a diagram showing a configuration of the sleep mode register 213. For instance, a sleep mode is indicated when the zeroth bit of the sleep mode register 213 holds 1, and a normal mode is indicated when holding 0. When 1 is written into the zeroth bit of the sleep mode register 213, the scheduler 230 performs scheduling for switching from the normal mode to the sleep mode.

The scheduler 230 performs scheduling for determining execution sequence of programs and a PP that executes a program, according to priorities of the programs.

In the normal mode, the scheduler 230 performs the scheduling at a timing dependent on a quantum time of any one of programs being executed by PPs. Specifically, the scheduler 230 performs the scheduling at a timing that is a predetermined time preceding a time when a program execution time becomes equal to a quantum time, and switches between the program executed and a program to be executed by the PP after the program execution time has become equal to the quantum time. The scheduler 230 performs the scheduling so as to assign an LP having a high priority among LPs in a ready state to a PP of which a program execution time has become equal to a quantum time.

In the normal mode, the scheduler 230 causes each PP to execute a program. That is to say, the scheduler 230 sets operation states of all LPs assigned to the PP to a running state.

In the sleep mode, the scheduler 230 causes only some of the PPs to execute host processing programs. In addition, the scheduler 230 does not cause the PPs to execute a media processing program. To put it differently, the scheduler 230 performs the scheduling so as not to cause at least one of the PPs to execute a program.

The scheduler 230 sets an operation state of an LP which is assigned to a PP and executes a host processing program to a running state, and an operation state of another LP which is assigned to a PP and corresponds to a media processing program to a suspended ready state. Here, even in the case where there is an LP in a suspended ready state or a ready state among LPs which execute media processing programs and where there is a PP to which no LP is assigned, the scheduler 230 does not assign the LP which executes a media processing program to the PP.

Moreover, when an operation mode is switched from the normal mode to the sleep mode, the scheduler 230 performs the scheduling at a timing not dependent on a quantum time. In other words, the scheduler 230 performs the scheduling at a timing dependent on a timing at which setting of the sleep mode register 213 is changed.

The context memory 250 stores a context used on an LP. The context is control information, data information, and the like that are necessary for executing a program.

The context transfer control unit 240 writes a context of an executed program into the context memory 250. Furthermore, the context transfer control unit 240 reads a context of a program to be executed from the context memory 250, and transfers the read context to a PP to which an LP corresponding to the program is assigned.

In the sleep mode, the clock suspension unit 120 suspends clock supply to a PP to which no LP is assigned among PPs.

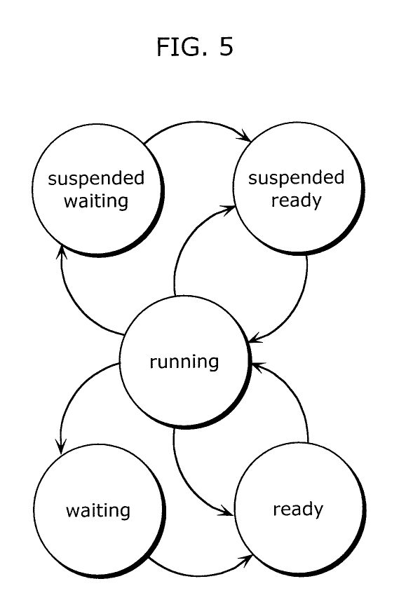

FIG. 5 is a diagram showing the state transition of an LP. The state transition is performed by the scheduler 230.

Next, the operation of the virtual multiprocessor 100 according to Embodiment 1 of the present invention will be described.

First, the operation of the virtual multiprocessor 100 in the normal mode will be described.

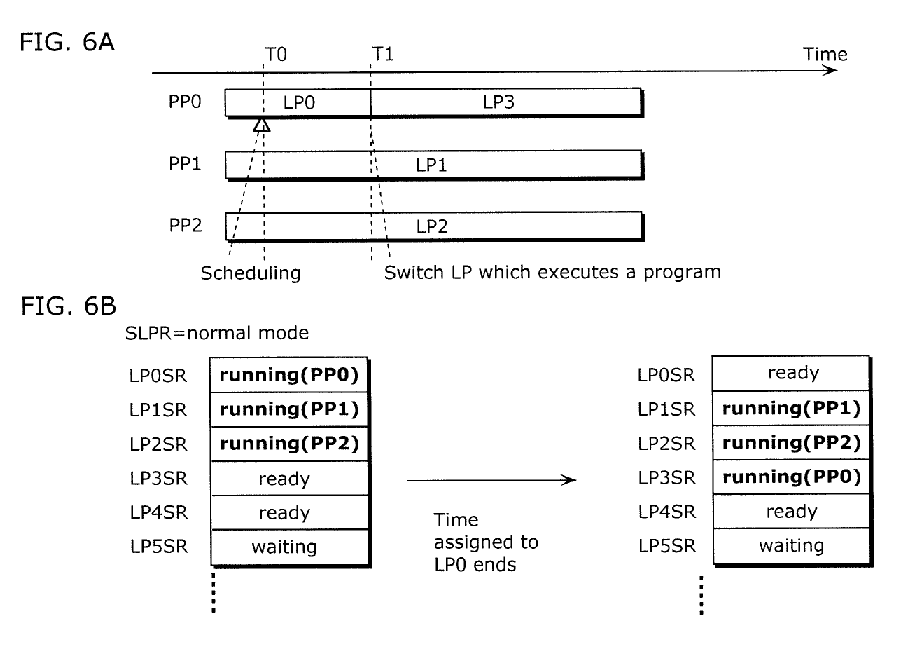

FIG. 6A is a diagram showing an example of LPs each of which is assigned to a corresponding one of PPs in the normal mode. FIG. 6B is a diagram showing an example of states of LPs.

LP0, LP1, and LP2 are assigned to PP0, PP1, and PP2 before time T1, respectively. It is to be noted that programs executed on LP0 to LP2 may be host processing programs or media processing programs.

Program execution being performed on LP0 is terminated at time T1. The scheduler 230 starts scheduling at time T0 that is a predetermined time preceding time T1.

It is assumed in the present embodiment that a priority of the scheduling is determined using the round-robin fashion. That is to say, the priority is higher with a smaller ID of an LP, and a priority of an LP corresponding to an executed program is set the lowest.

Accordingly, after a time assigned to LP0 ends, an LP having the next highest priority among LPs in a ready state is LP3. Thus, the scheduler 230 determines LP3 next to LP0 as an LP to be assigned to PP0. In addition, the scheduler 230 notifies the context transfer control unit 240 that LP3 is the LP to be assigned to PP0 next.

The context transfer control unit 240 reads a context of LP3 from the context memory 250, and transfer the read context to PP0.

Here, PP0 to PP2 can hold two contexts, respectively. Accordingly, overhead when switching between the contexts is reduced.

Furthermore, at time T1 the VMPC 200 notifies PP0 that an execution time of LP0 has become equal to the time assigned to LP0. PP0 starts executing a program corresponding to LP3 using the context of LP3 that has been transferred by the context transfer control unit 240.

Next, the operation of the virtual multiprocessor 100 when switching from the normal mode to the sleep mode will be described.

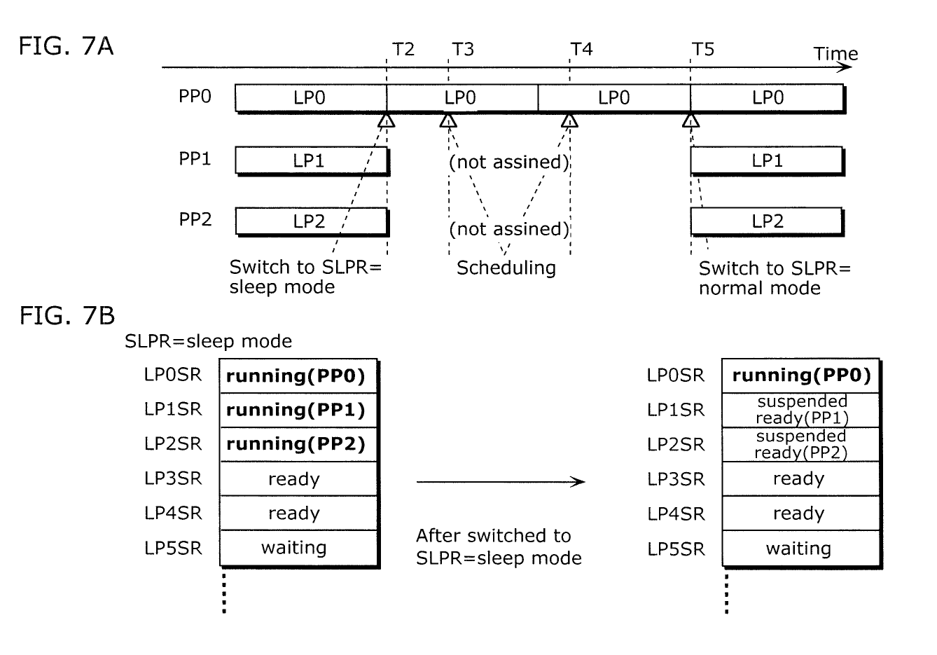

FIG. 7A is a diagram showing LPs each of which is assigned to a corresponding one of PPs when switching to the normal mode or the sleep mode. FIG. 7B is a diagram showing a state of each LP when switching to the sleep mode. Here, a program to be executed on LP0 is a host processing program, and a program to be executed on LP1 or LP2 is a media processing program.

When switching to the sleep mode is determined on a host processing program, a privilege level of a program being executed on LP0 is switched from a user level to a system level.

The program being executed on PP0 and having the system level writes 1 into the zeroth bit of the sleep mode register 213 at time T2. The scheduler 230 detects that the setting of the sleep mode register 213 has been changed, and starts the scheduling. Moreover, the scheduler 230 detects a PP (in this example, PP0) having accessed the sleep mode register 213, and puts LPs assigned to PPs other than PP0, that is, LP1 and LP2, into the suspended ready state. Furthermore, the scheduler 230 assigns LP0 to PP0, and causes PP0 to continue the program execution.

When a scheduling start time (time T3 and time T4) comes, the scheduler 230 reassigns LP0 to PP0, and does not assign LPs in the ready state or the suspended ready state to PP1 and PP2 even though the LPs exist.

At time T5, PP0 writes 0 into the zeroth bit of the sleep mode register 213, and the scheduler 230 is activated. The scheduler 230 respectively assigns, to PP1 and PP2, LP1 and LP2 that have been respectively assigned to PP1 and PP2 previously, and causes PP0 to PP2 to start the program execution. To put it differently, after the setting of the sleep mode register 213 has been changed to the normal mode, the scheduler 230 preferentially assigns, to a PP, an LP temporarily suspended when switching to the sleep mode.

Meanwhile, from time T2 to time T5, the clock suspension unit 120 suspends the clock supply to PP1 and PP2.

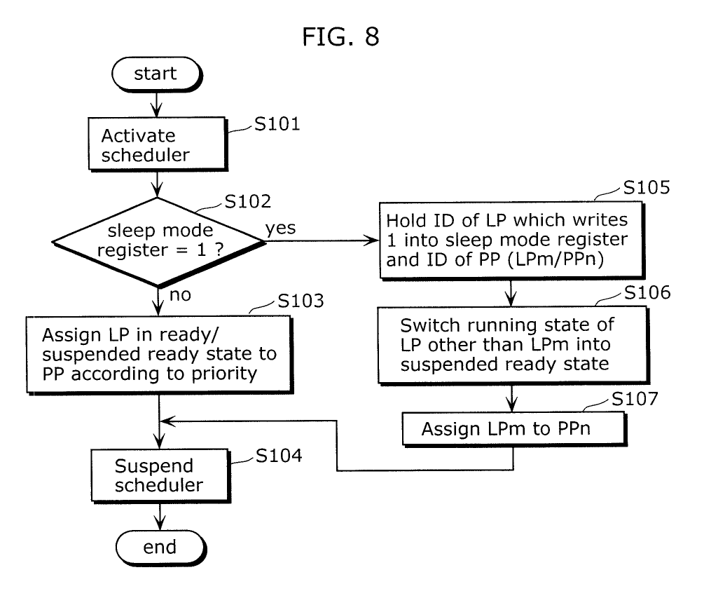

FIG. 8 is a flow chart showing a flow of a scheduling operation in the normal mode and the sleep mode.

First, the scheduler 230 is activated (S101). Specifically, the scheduler 230 is activated when a value held by the sleep mode register 213 is changed or at a time when a program execution time of a program being executed on a PP is a time that is a predetermined time preceding a time matching with a quantum time.

Next, the scheduler 230 judges whether the value held by the sleep mode register 213 is 1 or 0 (S102). In the case where the value held by the sleep mode register 213 is 0 (No in S102), that is, in the normal mode, an LP having a high priority among LPs in the ready state or the suspended ready state is assigned to a PP executing a program of which an assigned time ends (S103).

Next, the scheduler 230 is suspended (S104).

On the other hand, in the case where the value held by the sleep mode register 213 is 1 (Yes in S102), that is, when the normal mode is switched to the sleep mode, the scheduler 230 temporarily suspends execution of programs other than the program that performed the switching. In other words, the scheduler 230 temporarily suspends execution of a media processing program among programs being executed on a PP.

To be more precise, first, the scheduler 230 obtains the ID of the LP that has written 1 into the sleep mode register 213 and the ID of the PP, and holds the IDs (S105). That is to say, the scheduler 230 obtains the ID of the LP that is executing the host processing program and the ID of the PP to which the LP is assigned, and holds the IDs.

Next, the scheduler 230 switches the operation states of the LPs other than the LP having the ID obtained in step S105 from the running state to the suspended ready state (S106). At this time, in the case where the LPs in the running state other than the LP having the ID obtained in step S105 are accessing the outside of the virtual multiprocessor 100, the scheduler 230 waits until the accessing is completed and switches the operation states of the LPs to the suspended ready state after the accessing is completed.

In addition, the scheduler 230 assigns the LP having the ID obtained in step S105 to the PP having the ID obtained likewise, and causes the PP to continue the program execution (S107).

Next, the scheduler 230 is suspended (S104).

As described above, in the virtual multiprocessor 100 according to Embodiment 1 of the present invention, the scheduler 230 causes some of the PPs to execute the host processing programs in the sleep mode, and other PPs to temporarily suspend the execution of the media processing programs. Accordingly, suspending the clock supply to the PPs not executing the programs can reduce the power consumption.

Furthermore, when switching from the normal mode to the sleep mode, the virtual multiprocessor 100 performs the scheduling at a timing not dependent on a quantum time. Consequently, since the virtual multiprocessor 100 can perform the scheduling immediately at the time of switching to the sleep mode, overhead when switching to the sleep mode can be reduced. In addition, since the virtual multiprocessor 100 can perform control for the clock supply or the suspension of the clock supply to the physical processors 110 with low granularity, it is possible to achieve an extremely high power consumption reduction effect.

Although the virtual multiprocessor 100 according to Embodiment 1 of the present invention has been described above, the present invention is not limited to the present embodiment.

For instance, although the above description has described the example where only one LP that executes the host processing program is assigned to one PP and the program is executed, two or more LPs that execute the host processing program may be assigned to the PP while switching between the LPs.

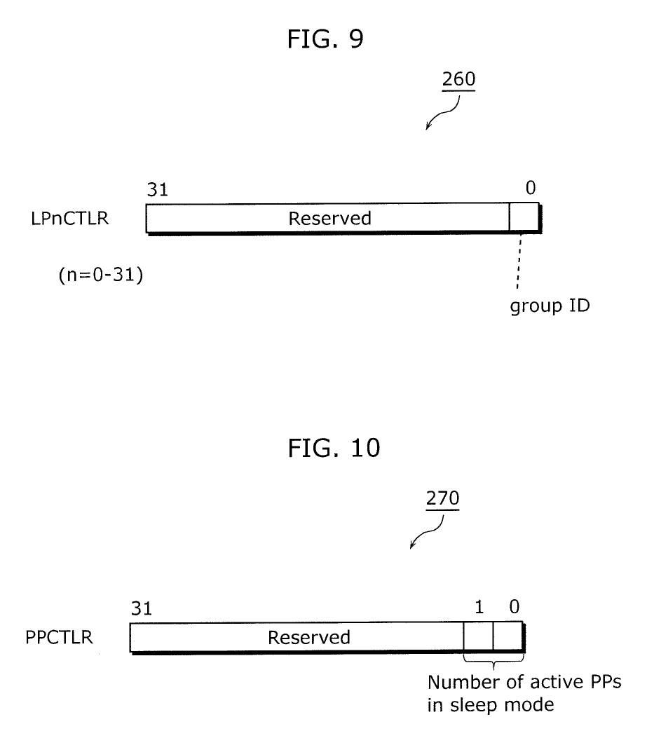

In this case, the VMPC 200 may further include an LP control register 260, in addition to the configuration shown in FIG. 1. FIG. 9 is a diagram showing a configuration of the LP control register 260.

The LP control register 260 is a register in which host processing programs to be executed in the sleep mode are set. The LP control register 260 includes 32 registers LPnCTLR (where n=0 to 31). The group ID is set to the zeroth bit of each register LPnCTLR. The group ID is information indicating whether or not an LP is assigned in the sleep mode. Specifically, group ID=0 is set to a register LPnCTLR corresponding to LPs which execute host processing programs. On the other hand, group ID=1 is set to a register LPnCTLR corresponding to LPs which execute media processing programs.

In the sleep mode, while switching to one PP, the scheduler 230 causes the PP to execute a program corresponding to the LPs to which group ID=0 is set. In addition, the scheduler 230 puts the LPs to which group ID=1 is set into the suspended ready state, and does not cause the PP to execute the program corresponding to the LPs.

Moreover, in the case where 1 is written into the sleep mode register 213 when PPs are executing host processing programs in parallel, while switching to one PP, the scheduler 230 causes the PP to execute the program corresponding to the LPs to which group ID=0 is set after completing the processing of the host processing programs.

With this, even in the case where the host processing programs are executed on the LPs, the same effect can be obtained.

Furthermore, although only one PP executes the program in the sleep mode in the above description, two or more PPs may execute programs. In other words, only some of the PPs included in the virtual multiprocessor 100 may execute the programs.

In this case, the VMPC 200 may further include a PP control register 270. FIG. 10 is a diagram showing a configuration of the PP control register 270.

The PP control register 270 is a register in which the number of PPs caused to operate in the sleep mode is set.

In the sleep mode, the scheduler 230 maps an LP to as many PPs as the number of PPs set to the PP control register 270.

As a result, in the sleep mode, host processing programs can be executed on the PPs in parallel.

Moreover, although the program to be executed in the sleep mode is the host processing program included in the mobile phone application program in the above description, the present invention is not limited to this.

Furthermore, although the virtual multiprocessor 100 includes three PPs in the above description, the virtual multiprocessor 100 may include one or more PPs. Moreover, in the case where the virtual multiprocessor 100 includes only one PP, in the sleep mode, the scheduler 230 puts an LP of the one PP into the suspended ready state, and does not cause the PP to execute a program. In addition, the clock suspension unit 120 suspends the clock supply to the one PP.

### Embodiment 2

Embodiment 2 of the present invention will describe a mobile phone including the virtual multiprocessor 100 according to above-mentioned Embodiment 1.

First, a configuration of a mobile phone 500 according to Embodiment 2 of the present invention will be described.

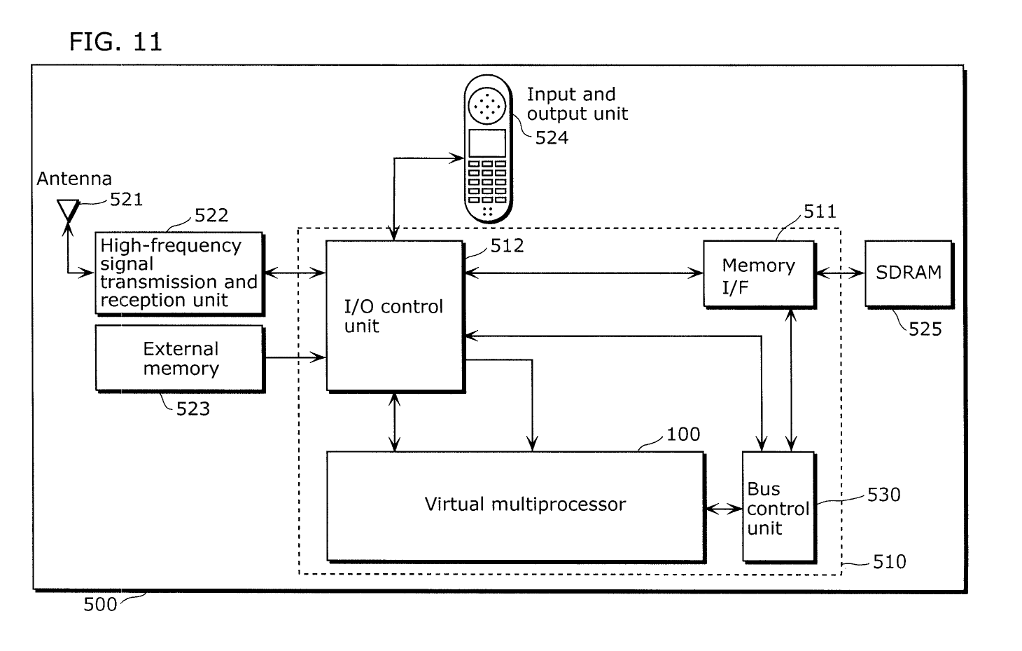

FIG. 11 is a functional block diagram showing the configuration of the mobile phone 500 according to Embodiment 2 of the present invention. The mobile phone 500 is a mobile phone with a music reproduction function.

The mobile phone 500 shown in FIG. 11 includes a system LSI 510, an antenna 521, a high-frequency signal transmission and reception unit 522, an external memory 523, an input and output unit 524, and a SDRAM 525.

The high-frequency signal transmission and reception unit 522 transmits and receives call data and the like via the antenna 521.

The external memory 523 accumulates music data.

The input and output unit 524 is a mobile phone receiver with a speaker.

The SDRAM 525 temporarily stores music data to be reproduced, music data on which reproduction processing has been performed, and the like.

The system LSI 510 is, for example, a one-chip semiconductor integrated circuit. The system LSI 510 includes the virtual multiprocessor 100, a bus control unit 530, a memory I/F 511, and an I/O control unit 512. It is to be noted that only the virtual multiprocessor 100 may be configured as the one-chip semiconductor integrated circuit or any one or more of the virtual multiprocessor 100, the bus control unit 530, and the memory I/F 511 may be configured as the one-chip semiconductor integrated circuit.

The virtual multiprocessor 100 is the virtual multiprocessor 100 described in Embodiment 1.

The memory I/F 511 writes and reads data to and from the SDRAM 525.

The I/O control unit 512 controls data input and output with the high-frequency signal transmission and reception unit 522, the external memory 523, and the input and output unit 524.

The bus control unit 530 controls buses connecting to the virtual multiprocessor 100, the memory I/F 511, and the I/O control unit 512.

Next, the operation of reproducing the music data, which is accumulated in the external memory 523, in the mobile phone 500 will be described.

First, the I/O control unit 512 reads the music data accumulated in the external memory 523. The I/O control unit 512 stores the read music data in the SDRAM 525 via the memory I/F 511.

The virtual multiprocessor 100 reads the music data from the SDRAM 525 via the memory I/F 511 and the bus control unit 530. The virtual multiprocessor 100 performs the reproduction processing on the read music data. The virtual multiprocessor 100 stores, in the SDRAM 525, the music data on which the reproduction processing has been performed.

The I/O control unit 512 reads, via the I/O control unit 511, the processed music data stored in the SDRAM 525. The I/O control unit 512 transmits the read music data to the input and output unit 524.

The input and output unit 524 causes the speaker to emit a sound based on the read music data transmitted from the I/O control unit 512.

Here, while performing the reproduction processing on the music data, the virtual multiprocessor 100 is not always performing the processing using all PPs, but there is a period of time in which it is not necessary to execute programs other than some programs (the host processing programs described in Embodiment 1). In this period of time, the virtual multiprocessor 100 puts one PP active, and causes only a host processing program to be executed on the PP. This can reduce the power consumption of the mobile phone 500.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to virtual multiprocessors, system LSIs, mobile phones, and control methods for virtual multiprocessor, and especially to mobile communication apparatuses such as a mobile phone including a virtual multiprocessor.

What is claimed is:

1. A virtual multiprocessor comprising:
one or more processors that execute programs while switching between the programs at each of assigned times;
a scheduling unit configured to determine execution sequence of the programs and said one or more processors that are to execute one or more of the programs;
an assigned time register that holds the assigned times each of which is associated with a corresponding one of the programs; and
a mode register in which one of a first mode and a second mode is set,
wherein said scheduling unit is configured to determine the execution sequence of the programs and said one or more processors that are to execute the one or more of the programs, at a timing dependent on an assigned time associated with a corresponding one of the programs being executed by said one or more processors, in the case where the first mode is set in said mode register, and to determine the execution sequence of the programs and said one or more processors that are to execute the one or more of the programs so that at least one of said one or more processors does not execute the programs, at a timing not dependent on the assigned time, in the case where the second mode is set in said mode register.

2. The virtual multiprocessor according to claim 1, further comprising
a clock suspension unit configured to suspend clock supply to a processor that is not executing the programs, among said one or more processors, in the case where the second mode is set in said mode register.

3. The virtual multiprocessor according to claim 1,
wherein said one or more processors are a plurality of processors, and
said scheduling unit is configured to determine the execution sequence of the programs and said one or more processors that are to execute the one or more of the programs so that only some of said plurality of processors execute the programs, in the case where the second mode is set in said mode register.

4. The virtual multiprocessor according to claim 3,
wherein said scheduling unit is configured to detect a change in a setting of said mode register, and to determine the execution sequence of the programs and said one or more processors that are to execute the one or more of the programs so that the at least one of said one or more processors does not execute the programs, at the timing not dependent on the assigned time, when the change from the first mode to the second mode is detected.

5. The virtual multiprocessor according to claim 4,
wherein said scheduling unit is configured to temporarily suspend execution of some of the programs being executed by said plurality of processors, when the setting of said mode register is changed from the first mode to the second mode, and to cause said plurality of processors to preferentially execute the programs whose execution has been temporarily suspended, after the setting of said mode register is changed from the second mode to the first mode.

6. The virtual multiprocessor according to claim 4,
wherein the programs include one or more first programs and one or more second programs, and
said scheduling unit is configured to determine the execution sequence of the programs and said one or more processors that are to execute the one or more of the programs so as to cause each of said one or more processors to execute one of the one or more first programs and the one or more second programs, in the case where the first mode is set in said mode register, to cause some of said plurality of processors that are executing one of the one or more first programs to continue to execute the one of the one or more first programs, and to cause some of said plurality of processors that are executing one of the one or more second programs to temporarily suspend execution of the one of the one or more second programs.

7. The virtual multiprocessor according to claim 6,
wherein the setting of said mode register is changed by the one of the one or more first programs executed by said plurality of processors, and
said scheduling unit is configured to cause a processor that is executing a third program to continue to execute the third program, among said plurality of processors, when the setting of said mode register is changed from the first mode to the second mode by the third program, and to cause a processor that is executing programs other than the third program to temporarily suspend execution of the programs, among said plurality of processors, the one or more first programs including the third program.

8. The virtual multiprocessor according to claim 6, further comprising
a program setting register in which one of a first value and a second value is set to each of the first programs,
wherein said scheduling unit is configured to cause the only some of said plurality of processors to execute, among the first programs, first programs to which the first value is set in said program setting register, while switching between the first programs to which the first value is set.

9. The virtual multiprocessor according to claim 6, further comprising:
a program setting register in which one of a first value and a second value is set to each of the first programs; and
a number-of-processors register in which the number of processors that execute the programs in the second mode, among said plurality of processors, is set,
wherein said scheduling unit is configured to cause a number of said plurality of processors equaling the number of processors set in said number-of-processors register to execute, among the first programs, first programs to which the first value is set in said program setting register, in the case where the second mode is set in said mode register.

10. The virtual multiprocessor according to claim 1,
wherein said one or more processors are one processor, and
said scheduling unit is configured to inhibit said one processor from executing the programs, in the case where the second mode is set in said mode register.

11. A system LSI comprising the virtual multiprocessor of claim 1.

12. A mobile phone comprising the system LSI of claim 11.

13. A control method for use in a virtual multiprocessor that includes one or more processors that execute programs while switching between the programs at each of assigned times, a scheduling unit that determines execution sequence of the programs and the one or more processors that are to execute one or more of the programs, an assigned time register that holds the assigned times each of which is associated with a corresponding one of the programs, and a mode register in which one of a first mode and a second mode is set, said control method comprising:
determining, by the scheduling unit, the program sequence of the programs and the one or more processors that are to execute the one or more of the programs, at a timing dependent on an assigned time associated with a corresponding one of the programs being executed by the one or more processors, in the case where the first mode is set in the mode register; and
determining, by the scheduling unit, the execution sequence of the programs and the one or more processors that are to execute the one or more of the programs so that at least one of the one or more processors does not execute the programs, at a timing not dependent on the assigned time, in the case where the second mode is set in the mode register.
